(19) United States
(12) Patent Application Publication
(10) Pub. No.: US 2019/0043120 A1
(43) Pub. Date: Feb. 7, 2019

(54) DATABASE SEARCH-BASED NETWORK COMMUNICATION

(71) Applicant: William Ryu, New York, NY (US)

(72) Inventor: William Ryu, New York, NY (US)

(21) Appl. No.: 15/667,579

(22) Filed: Aug. 2, 2017

(51) Int. Cl. G06Q 30/08; G06F 17/30; G06Q 20/32; G06Q 20/08; H04L 29/06

(52) U.S. Cl. CPC G06Q 30/08; G06F 17/30876; H04L 65/1003; G06Q 20/0855; G06Q 20/3223

(57) ABSTRACT

A transaction request generated from a first computer device in a first transaction database is stored. The transaction request is provided to a plurality of subscriber computer devices, the subscriber computer devices subscribed to the first transaction database and at least one keyword associated with the transaction request. A plurality of transaction bids from at least one of the subscriber computer devices are received. The transaction bids are provided to the first computer device. Responsive to the first computer device selecting at least one of the transaction bids, a network session is established between the first computer device and a selected subscriber computer device associated with at least one of the selected transaction bids.

### TECHNICAL FIELD

The present invention relates generally to a method, system, and computer program product for generating a set of database search results. More specifically, the present invention relates to a method, system, and computer program product for contextually enhancing the database search results and establishing a network session between the related users based on such search results.

### BACKGROUND

A database can be used by a variety of applications for storing their respective data. For example, in a business organization, a common installation of a database may be used by the finance department to store financial data, by the human resources department to store employee information, by the development team to store product design data, and by many other departments in a similar manner.

In many cases, the database is stored in a server which share the database records so as to allow users to perform various types of transactions. A transaction type may include brokering a transaction in which one user to purchase an item as described in the database record, wherein such record was initially uploaded by another user. Another transaction type may include initiating a communication channel between two users for text chat or video chat.

### SUMMARY OF THE INVENTION

The illustrative embodiments provide a method, system, and computer program product. An embodiment includes a method that stores, using a processor and a memory, a transaction request generated from a first computer device in a first transaction database. The embodiment provides, using the processor and the memory, the transaction request to a plurality of subscriber computer devices, the subscriber computer devices subscribed to the first transaction database and at least one keyword associated with the transaction request. The embodiment receives, using the processor and the memory, a plurality of transaction bids from at least one of the subscriber computer devices. The embodiment provides, using the processor and the memory, the transaction bids to the first computer device. The embodiment establishes, using the processor and the memory, a network session between the first computer device and a selected subscriber computer device associated with at least one of the selected transaction bids, responsive to the first computer device selecting at least one of the transaction bids.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for database search-based network communication in accordance with an illustrative embodiment;

FIG. 4 depicts a flowchart of an example process of establishing a database search-based network communication in accordance with an illustrative embodiment; and

FIG. 5 depicts a flowchart of an example process of establishing a multimedia session during the database search-based network communication in accordance with an illustrative embodiment.

### DETAILED DESCRIPTION OF THE EMBODIMENTS

The illustrative embodiments recognize that the majority of the data processing systems and e-commerce solutions are designed for supply-centric models, which heavily rely on vendors and supplier resources. Because of this, the current systems have technological limitations in which end users spend a lot of time and energy on their research before engaging in various types of transactions in such data processing systems. Also, the value points resulting from such transactions are not market competitive, but determined by oligopoly competitive state, namely a state of limited competition, in which a market is shared by a small number of producers or sellers.

The illustrative embodiments recognize that the current data processing systems do not allow the end users and the providers to meaningfully engage in transactions which result in a market-competitive platform. For example, end users cannot create their own list of transaction requirements through the current data systems and let vendors and suppliers fulfill the transaction requirements. The illustrative embodiments recognize that, if suppliers undercut their competitors to win the bid to fulfill a transaction, it will generally lead to a beneficial outcome towards the end users as compared to the conventional supply centric model.

The illustrative embodiments recognize that the present invention may be implemented through a relational database in which the records are organized into a tabular format, having rows and columns in which the corresponding information can be stored in a “structured” format. Examples of a relational database includes SQL and IBM® DB2®. The records stored in a relational database can be retrieved by executing a query constructed through user input.

The illustrative embodiment also recognize that database-based transactions and network communications may instead occur through a non-relational database such as NoSQL. A NoSQL database environment is a non-relational and largely distributed database system that enables rapid, ad-hoc organization and analysis of extremely high-volume, disparate data types. NoSQL databases are sometimes referred to as cloud databases, non-relational databases, Big Data databases and a myriad of other terms and were developed in response to the sheer volume of data being generated, stored and analyzed by modern users (user-generated data) and their applications (machine-generated data).

In general, NoSQL databases have become the first alternative to relational databases, with scalability, availability, and fault tolerance being key deciding factors. They go well beyond the more widely understood legacy, relational databases (such as Oracle, SQL Server and DB2 databases) in satisfying the needs of today's modern business applications. A very flexible and schema-less data model, horizontal scalability, distributed architectures, and the use of languages and interfaces that are “not only” SQL typically characterize this technology. Contrary to misconceptions caused by its name, NoSQL does not prohibit structured query language (SQL). While it's true that some NoSQL systems are entirely non-relational, others simply avoid selected relational functionality such as fixed table schemas and join operations. For example, instead of using tables, a NoSQL database might organize data into objects, key/value pairs or tuples.

There are four general types of NoSQL databases, each with their own specific attributes:

Graph database—Based on graph theory, these databases are designed for data whose relations are well represented as a graph and has elements which are interconnected, with an undetermined number of relations between them. Examples include: Neo4j and Titan.

Key-Value store—we start with this type of database because these are some of the least complex NoSQL options. These databases are designed for storing data in a schema-less way. In a key-value store, all of the data within consists of an indexed key and a value, hence the name. Examples of this type of database include: Cassandra, DyanmoDB, Azure Table Storage (ATS), Riak, BerkeleyDB.

Column store—(also known as wide-column stores) instead of storing data in rows, these databases are designed for storing data tables as sections of columns of data, rather than as rows of data. While this simple description sounds like the inverse of a standard database, wide-column stores offer very high performance and a highly scalable architecture. Examples include: HBase, BigTable and HyperTable.

Document database—expands on the basic idea of key-value stores where “documents” contain more complex in that they contain data and each document is assigned a unique key, which is used to retrieve the document. These are designed for storing, retrieving, and managing document-oriented information, also known as semi-structured data. Examples include: MongoDB and CouchDB.

The illustrative embodiments recognize that the presently available tools or solutions do not address the needs or provide adequate solutions for these needs. The illustrative embodiments used to describe the invention generally address and solve the above-described problems and other problems related to establishing a network and multimedia sessions between different users from various types of environments.

An embodiment can be implemented as a software application. The application implementing an embodiment can be configured as a modification of an existing network communication platform, as a separate application that operates in conjunction with an existing communication platform, a standalone application, or some combinations thereof.

An embodiment enables a user to enter queries to search a database (relational or non-relational), in which the records are filtered through metadata tags associated with the keywords associated with the queries. The metadata tags that match the entered keywords will be placed at a higher position of relevancy of the retrieved database records. In some cases, an embodiment may not find any metadata tags that match or have a high degree of similarity with the searched keywords. Responsive to being unable to find any metadata tags, an embodiment may convert back to the default search algorithm, including an algorithm that matches the keywords of the queries with the other fields associated with the records in the database.

In the event that the keyword search generates a large number of search results, an embodiment may determine how many times the keyword matches the metadata tags of a search result as each search result may include two or more metadata tags. An embodiment may then arrange the search results based on the number of matches between the keyword and the metadata tags. An embodiment may list a search result with the highest number of matches at the top of the generated webpage displaying the database keyword search results.

An embodiment also enables a user to enter queries, including transaction requests, in database, and, in response, communicates the keyword information to other users previously subscribed to the database. In that case, the other subscribers to the database may upload database records, namely transaction bids, that match the entered keywords into the server network, which in turn enable the user to enter into a transaction with one or more of the subscribers who submitted the database records. For example, a user attempting to purchase an item enters a query with a keyword describing the item into the system. An embodiment then notifies the subscribers of the database about such keyword, and one of the subscribers, a seller, submits a database record that offers the searched items. The user may then enter into a transaction with such subscriber and complete the transaction as specified by the query and the uploaded database records.

In one embodiment of the present invention, a user may enable its status as a potential provider of an item then subscribe to the database which such item is to be listed. The potential provider may update his profile to include at least one metadata tag indicative of such record, e.g., item or service offered for a fee. For example, when a user desires to sell a video game and his bartending services, then the user may update its profile of the system to add metadata tags such as “video game” and “bartending.” An embodiment then enables another user to search via keywords the items already available on the database and/or a set of sellers whose profile includes the metadata tags that match such keywords. In another example, in response to the user submitting a keyword for searching an item or service that matches the metadata tags in the stored profile database, an embodiment provides a list of profiles containing the metadata tags.

An alternate embodiment may send notifications to the users whose profiles include such metadata tags. In another aspect, an embodiment may perform a real-time preliminary execution of the search query and preview to the user a running number of profiles that will be exposed through such search query.

In one embodiment of the present invention, a user can retrieve a plurality of database records, wherein the items or services associated with the database records can be provided together. In this embodiment, while an author of the database records may enter and complete separate transactions for each of one or more of the plurality of items indicated by the database records, the author may be able to provide all of the plurality of items together (often providing more incentives such as a discount) that would attract other users who wish to enter into a single transaction that covers subsets of transactions related with the plurality of database records.

For example, a seller of a laptop device can also offer other computer accessories together, wherein the seller can sell the bundle in a discounted price. In another embodiment, the system may list a seller's individual items, but allows the seller to bundle the items to be provided at a discounted price. In the same vein, the seller may have a garage sale during which she will sell each individual item at the normal price, but may also sell all items together at a discounted price.

In another embodiment, if a first user cannot provide all of the requested items associated with the database query, then the first user may request for other users to join him to supplement the rest of the missing item or services. In this manner, the group of user can provide the requested items and/or services together at a discount which may increase the likelihood of the user to select the newly formed group of users for the transaction. For example, if a user listed a set of services for her wedding, requesting a quote for florist, caterer, and DJ services. The florist may identify the list of services and confirm that he can provide the florist services, but not the rest. The florist may then generate an invite form for caterers and DJs to join the bid, and upon agreement with the seller parties, the newly formed group may be able to provide a price quote which would be likely to be purchased by the user.

In an embodiment, a user requesting a transaction, such as a seeker of the item and/or services, to select a bid from a plurality of transaction bid submissions. In one embodiment, the system may restrict the transaction bid selection to only a single seller or provider. In another embodiment, a user may select multiple winning bids. Throughout these embodiments, the system may allow the seeker to customize whether a winning bid with include only one seller or at least two sellers. In the event that at least two sellers are selected, the system divides the total payment made by the seeker into respective portions to be distributed to the selected bid winners.

In one embodiment of the present invention, a user can request a text chat session once the user establishes a network session with the author of a database record (e.g., transaction bid). When the recipient of the request accepts the text chat session request, the system initiates a text chat session between the user and the recipient to discuss about the searched database record. In another embodiment, the user may request to the recipient a video broadcast of items associated with the database record. In response to the recipient accepting a request for a video broadcast session, an embodiment determines whether a camera of the mobile device is available. If so, the embodiment activates the camera of the mobile device which will start streaming the searched item. Various embodiments may set a time threshold for video recording, which when exceeded or expired the video recording session is terminated. An embodiment may delete any stored video recording and/or the text chat transcript once the respective session is terminated, which is aimed to protect the privacy of the transaction made between the users.

For example, suppose a shopper finds an item offered by the bidder. Once the shopper clicks on a hyperlink associated with the item, the system generates a webpage displaying the list of details of such item. Included in the generated webpage are two graphic icons, in which one allows the shopper to request a text chat session with the seller offering the item while the other icon allows the shopper to request a video broadcasting of the offered item. In response to the shopper selecting either of the graphic icons, the seller may accept the request which the system communicates with the mobile device of the seller then activates said mobile device to initiate the requested communication session. In the case of the text chat session, both users may continue to communicate via network until one of them terminates the chat session. In the embodiment involving the video broadcast session, an embodiment activates the camera of the mobile device for a limited period of time (e.g., 30 seconds), and, once such period of time expires, disables the camera of said mobile device. In both cases, the system finally deletes any data exchanged between both users after terminating the session.

In one embodiment of the present invention, a third-party user may share a hyperlink of the database record, which can be shared in various websites and/or social media channels. Once a user accesses the shared hyperlink then completes a transaction related to the database record to which the shared hyperlink is directed, then an embodiment may provide notification and/or incentives to the third-party user who shared the hyperlink. In several embodiments, the incentive may be a monetary reward which can be a percentage commission of the total sales price, a discount offer for future purchases, or any other types of rewards contemplated by a user ordinarily skilled in the art.

For example, a third party user finds a database result describing an item for sale. The third party user shares a hyperlink of the database result on her Facebook® account page, which is then displayed in the newsfeed of many users. If one of the users accesses the hyperlink in the newsfeed and purchases the item, the system generates a reward for the third party user, wherein the reward in this example is a percentage of the price the purchaser had paid.

The illustrative embodiments are described with respect to certain types of transactions, messages, network sessions, bids, multimedia streams, network connections, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

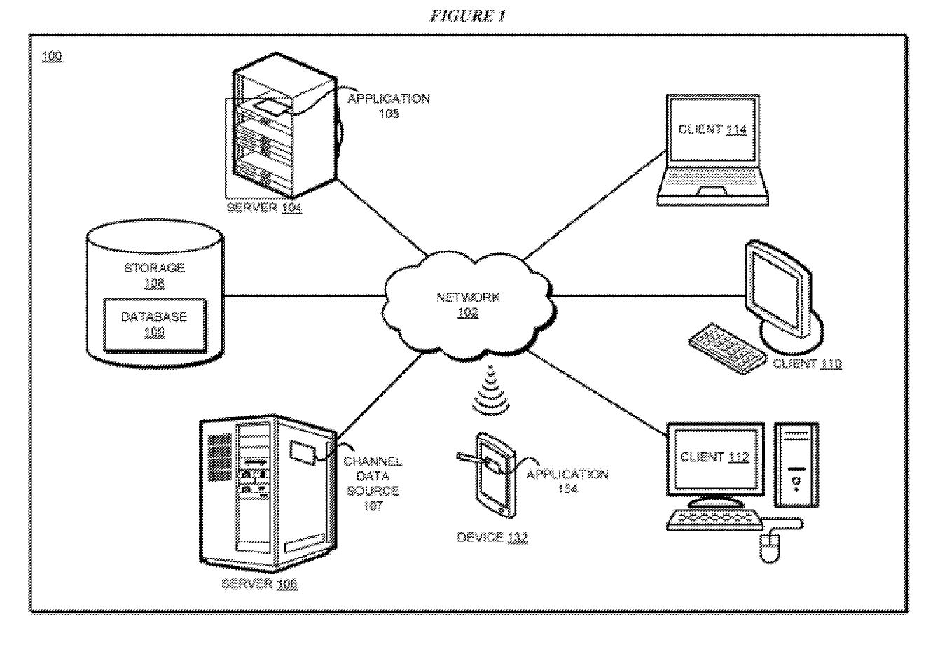

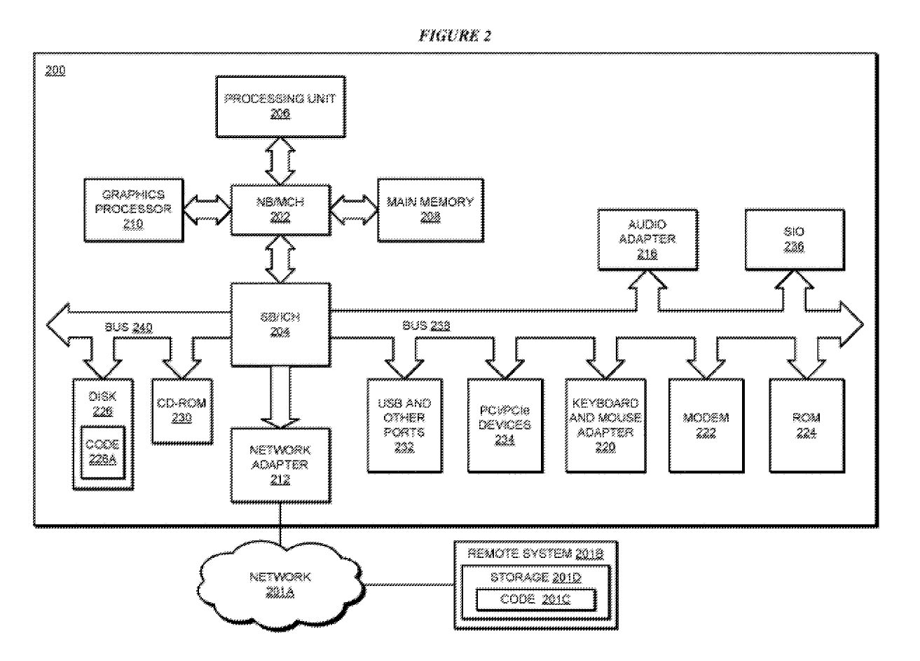

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 alone, application 134 alone, or applications 105 and 134 in combination implement an embodiment described herein. Channel data source 107 provides the past period data of the target channel or other channels in a manner described herein.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 and/or application 134 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

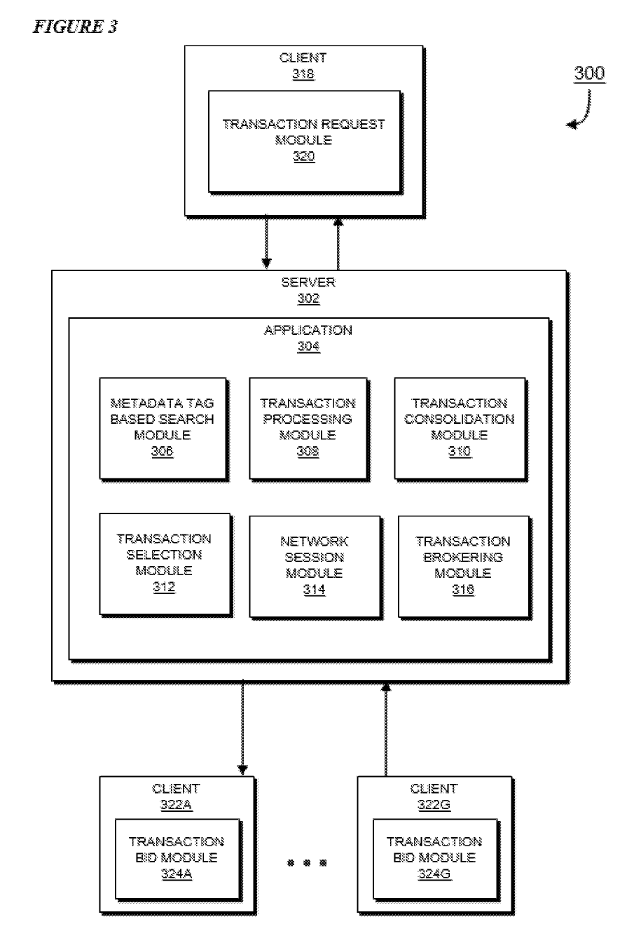

With reference to FIG. 3, this figure depicts a block diagram of an example configuration for database search-based network communication in accordance with an illustrative embodiment. Application 304 is an example of application 105 in FIG. 1 and operates on the server-side as shown in server 302, which is an example of server 104 in FIG. 1.

When a user inputs a query via transaction request module 320 and communicates the query to server 302, application 304 first extracts keywords from the query and transfers the keywords to metadata tag based search 306. Metadata tag based search module 306 receives the keywords and transforms the keywords as a sub-query to search the metadata column of the transaction database (e.g., database 109). The metadata column, not shown, may include the metadata tags associated with each of the database records uploaded by the users. If the search does not return any database query results, metadata tag based search module 306 constructs a second sub-query from the keywords which would search the rest of the columns of the transaction database.

In one embodiment, the transaction database may include a metadata column where the stored data in said column describes characteristics of the data representative of the transaction. In another embodiment, the transaction database may include a metadata column where the stored data in said column describes availability of the data representative of the transaction. In various embodiments, the availability of the data within the metadata column is linked to corresponding user who submitted the database record in which the column indicative of the availability of the data is stored.

Once query results are returned, application 304 communicates the query results to client 318 via the computer network. Transaction request module 320 may then select one of the query results to request a transaction with the user who submitted the database record corresponding to the query result. In other embodiments, transaction request module 320 may select none from the query results but rather submit a transaction request that invites transaction bids to be communicated back to client 318. In various embodiments, a transaction request may be unstructured data such as a series of character variables, structured data in which the character variables are stored in a table, a map, a hash, or any other types of data structure, and/or both. In some embodiments, a transaction request may be formed by a plurality of sub-requests. In some embodiments, the sub-requests can be arranged in a checklist format in which client 318 may request to enter additional sub-requests by using keyboard stroke(s), mouse click(s), or touchscreen interaction(s). For example, a transaction request may have a single text box for client 318 to enter a single string of sub-request. By pressing the “tab” button on the keyboard, application 304 may generate a second text box so as to allow the user to enter a second transaction sub-request.

In response to receiving the submission of the transaction request, application 304 then uses transaction processing module 308 to communicate the transaction request to clients 322A —322G, in particular clients who are subscribed to the transaction database. In another embodiment, application stores the transaction request into a second transaction database, in which clients 322A-322G may instruct application 304 to execute a search query to find the appropriate transaction request on which they can submit transaction bids. In this embodiment, the query for the transaction request may be performed by metadata tag based search module 306, in the same manner described herein above.

In various embodiments, transaction bids are requests by clients 322A-322G to enter into a network session with client 318 to fulfill the transaction request and thus complete the transaction. In the scenario where a transaction requests include a plurality of sub-requests, transaction processing module 308 allows clients 322A-322G to identify a subset of sub-requests that they will be able to fulfill. For example, suppose a transaction request include a purchase for an Apple® MacBook® Pro. Such identification may include a user interface interaction in which the user submitting the transaction bid can place a check graphic next to the sub-request, through mouse click(s). The transaction request may have four sub-requests: (1) manufactured after 2015; (2) silver color; (3) 1 TB of internal data storage available; and (4) under $1400. Once application 304 communicates the transaction request to clients 322A-322G, client 322D may submit a transaction bid that may be able to fulfill sub-requests (1) and (3), during which client 322D will identify such capabilities then submit the transaction bid back to server 302 for further processing.

In response to detecting that transaction bids have been submitted via transaction bid modules 324A-324G, application 304 uses transaction processing module 308 to communicate the transaction bid records back to client 318, upon which the user may select one or more of the transaction bids to establish a network session with one or more of clients 322A-322G which corresponds to the selected transaction bid(s). In response to the user selection, application 304 uses transaction selection module 312 to notify the client corresponding to the selected transaction bid. If the user selects two or more transaction bids, transaction selection module 312 may notify the clients to establish an n-way network session with client 318 to complete the requested transaction. In various embodiments, a network session is an established communication session between two clients, a client and a server, or a combination of clients and servers. In some embodiments, a network session may also be a user session in which server 302 stores any cookies or cache for the user(s) for a period of time.

As described above, client 318 may submit multiple transaction requests through transaction request module 320, each of which may request for a different type of a transaction. client 322A may be available to cater to multiple transaction requests submitted by client 318. In this scenario, application 304 utilizes transaction consolidation module 310 to combine multiple transaction bids that client 322A may submit through the transaction bid module 324A. Transaction consolidation module 310 allows the transaction bids to be combined and offered with additional incentives (e.g., discounted price) as compared to offering the transaction bids separately. In another embodiment, clients 322A and 322B may communicate with each other to submit its respective transaction bids, which, when combined, may satisfy different parts of the multiple transaction requests submitted by client 318. In this case, transaction consolidation module 310 allows the transaction bids to be combined and offered with additional incentives, thus improving their changes of being selected by client 318.

After sending notifications to clients that submitted the selected transaction bids, application 304 receives the confirmation from said clients then utilizes network session module 314 to establish a network session between client 318 and the selected clients. During the network session, the users may complete the transaction, including calling a payment module (not shown) to remunerate the selected clients if the transaction is completed successfully. Other types of activities available in such network session includes network session module 314 establishing a text chat session or video broadcast session between client 318 and the selected clients. In various embodiments, the video broadcast session provides a time limit in which broadcast session terminates after said time limit is exceeded or expired. In one embodiment, application 304 deletes any cache, history, cookies, or any other data involved with the network session, including text chat session and the video broadcast session, as said network session is terminated.

In addition, if the transaction is completed, application 304 may process remuneration towards the client associated with the selected transaction bid. In various embodiments, remuneration may be payments for selling items or furnishing certain types of services. In other embodiments, remuneration may be credit towards future payment in the scenario that the client associated with the selected transaction bid may create a new transaction request himself.

Application 304 also includes transaction brokering module 316, which allows third party devices (not shown) to share the transaction request submitted by client 318 in computer networks outside of system 300. For example, a third party device may share the transaction request on a social network website, such as Facebook® or Instagram®, in which transaction request may be displayed as URL or any other identifier that directs network traffic to such transaction request. If any transaction bids are submitted through the shared URL and the transaction is successfully completed, application 304 may provide incentives to the third party who shared the transaction request outside the computer networks.

In various embodiments, those of ordinary skill in the art will be able to conceive many other ways of establishing a network session through database search and the same are contemplated within the scope of the illustrative embodiments. For example, client 318 may have both transaction request module 320 and transaction bid module 324, which allows client 318 to create transaction requests while submitting transaction bids to fulfill other types of transaction requests. Conversely, client 322A may also have transaction request module 320 and transaction bid module 324, and may request and/or offer to complete transactions.

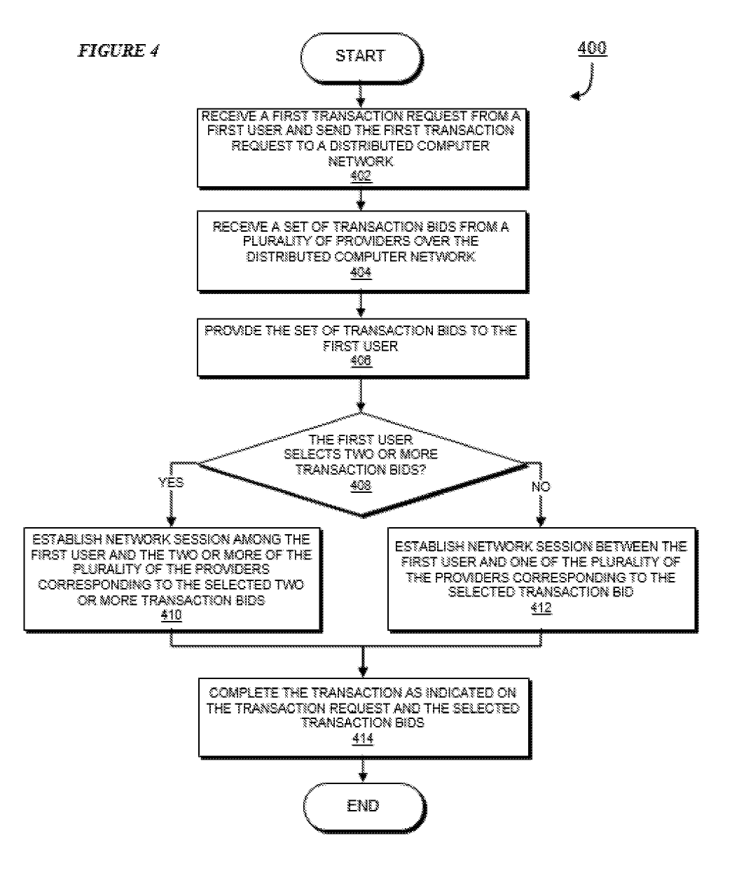

With reference to FIG. 4, this figure depicts a flowchart of an example process of establishing a database search-based network communication in accordance with an illustrative embodiment. Process 400 can be implemented by application 304 in FIG. 3.

The application receives a first transaction request from a first user and sends the first transaction request to a distributed computer network (block 402). Once the first transaction request is communicated, the application receives a set of transaction bids from a plurality of providers of said distributed computer network (block 404). The application then provides the set of transaction bids to the first user (block 406).

The application then receives an indication from the first user whether the first user selected two or more transaction bids (block 408). If so (“Yes” path of block 408), the application establishes a network session among the first user and the two or more of the plurality of the providers corresponding to the selected two or more transaction bids (block 410). If not (“No” path of block 408), the application establishes a network session between the first user and one of the plurality of the providers corresponding to the selected transaction bid (block 412).

In response to the network session being established, the application completes the transaction as indicated on the transaction request and the selected transaction bids (block 414). The application ends process 400 thereafter.

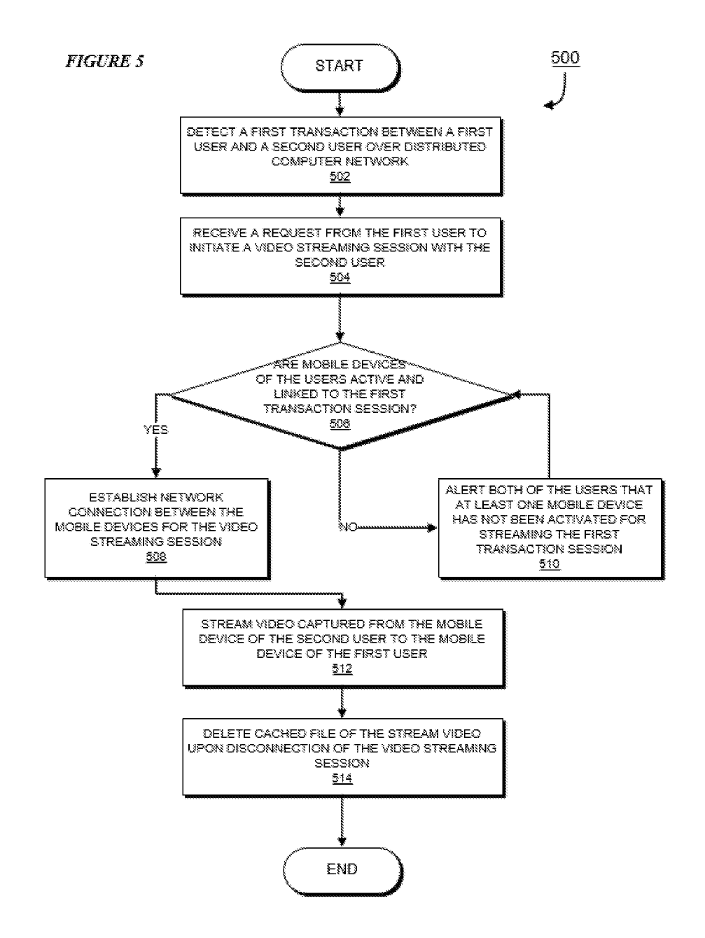

With reference to FIG. 5, this figure depicts a flowchart of an example process of establishing a multimedia session during the database search-based network communication in accordance with an illustrative embodiment. Process 500 can be implemented by application 304 in FIG. 3.

The application detects a first transaction between a first user and a second user over distributed computer network (block 502). During the first transaction, the application receives a request from the first user to initiate a video streaming session with the second user (block 504). The application processes the request to determine whether mobile devices of the first and the second user are active and linked to the first transaction session (block 506).

If the application determines that the mobile devices are active and linked to the first transaction session (“Yes” path of block 506), the application establishes a network connection between the mobile devices for the video streaming session (block 508). Conversely, if the application determines that the mobile devices are not active or not linked to the first transaction session (“No” path of block 508), the application alerts the first user and the second user that at least one of the mobile devices has not been activated for streaming the first transaction session (block 510). In addition, the application loops back into determining whether the mobile devices have become active and linked after a preset time period passes after the alert had been generated.

If the network connection between the mobile devices has been established, the application streams video captured from the mobile device of the second user to the mobile device of the first user (block 512). After the streaming is completed, the application deletes any cached or stored files or registries involved with streaming the video and disconnects the video streaming session (block 514). The application ends process 500 thereafter.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
storing, using a processor and a memory, a transaction request generated from a first computer device in a first transaction database;
providing, using the processor and the memory, the transaction request to a plurality of subscriber computer devices, the subscriber computer devices subscribed to the first transaction database and at least one keyword associated with the transaction request;
receiving, using the processor and the memory, a plurality of transaction bids from at least one of the subscriber computer devices;
providing, using the processor and the memory, the transaction bids to the first computer device; and
responsive to the first computer device selecting at least one of the transaction bids, establishing, using the processor and the memory, a network session between the first computer device and a selected subscriber computer device associated with at least one of the selected transaction bids.

2. The method of claim 1, further comprising:
detecting that a transaction as specified by the transaction request and the at least one of the selected transaction bids is complete; and
terminating the established network session.

3. The method of claim 1, wherein the first computer device and the selected subscriber computer device establishes a text chat session after the network session is established and while the network session is active.

4. The method of claim 1, wherein the first computer device and the selected subscriber computer device establishes a video streaming session after the network session is established and while the network session is active.

5. The method of claim 4, further comprising:
determining whether mobile devices corresponding to both of the first computer device and the selected subscriber computer device are active and linked to the established network session; and
if so, causing cameras of the mobile devices to become activated for predetermined time as previously specified by the established network session, wherein the cameras of the mobile devices are deactivated once the predetermined time period expires.

6. The method of claim 1, further comprising:
detecting that the transaction request includes a first sub-request and a second sub-request;
receiving a plurality of first sub-request transaction bids from a first sub-group of the subscriber computer devices and a plurality of second sub-request transaction bids from a second sub-group of the subscriber computer devices; and
in response to the first computer device selecting one of the plurality of the first sub-request transaction bid and one of the plurality of the second sub-request transaction bid, establishing the network session among the first computer device and the subscriber computer devices corresponding to the selected first sub-request transaction bid and the selected second sub-request transaction bid.

7. The method of claim 1, wherein the transaction request can be shared by a third party device to another computer network environment via a shared URL, and further comprising:
responsive to a transaction bid submitted through the shared URL being selected by the first computer device, generating transaction credit for the third party device.

8. A computer usable program product comprising one or more computer-readable storage devices, and computer usable code stored on at least one of the one or more storage devices, the stored computer usable code comprising:
program instructions to store a transaction request generated from a first computer device in a first transaction database;
program instructions to provide the transaction request to a plurality of subscriber computer devices, the subscriber computer devices subscribed to the first transaction database and at least one keyword associated with the transaction request;
program instructions to receive a plurality of transaction bids from at least one of the subscriber computer devices;
program instructions to provide the transaction bids to the first computer device; and
program instructions to establish a network session between the first computer device and a selected subscriber computer device associated with at least one of the selected transaction bids, responsive to the first computer device selecting at least one of the transaction bids.

9. The computer usable program product of claim 8, further comprising:
program instructions to detect that a transaction as specified by the transaction request and the at least one of the selected transaction bids is complete; and
program instructions to terminate the established network session.

10. The computer usable program product of claim 8, wherein the first computer device and the selected subscriber computer device establishes a text chat session after the network session is established and while the network session is active.

11. The computer usable program product of claim 8, wherein the first computer device and the selected subscriber computer device establishes a video streaming session after the network session is established and while the network session is active.

12. The computer usable program product of claim 11, further comprising:
program instructions to determine whether mobile devices corresponding to both of the first computer device and the selected subscriber computer device are active and linked to the established network session; and
program instructions to cause cameras of the mobile devices to become activated for predetermined time as previously specified by the established network session, wherein the cameras of the mobile devices are deactivated once the predetermined time period expires.

13. The computer usable program product of claim 8, further comprising:
program instructions to detect that the transaction request includes a first sub-request and a second sub-request;
program instructions to receive a plurality of first sub-request transaction bids from a first sub-group of the subscriber computer devices and a plurality of second sub-request transaction bids from a second sub-group of the subscriber computer devices; and
program instructions to establish the network session among the first computer device and the subscriber computer devices corresponding to the selected first sub-request transaction bid and the selected second sub-request transaction bid, in response to the first computer device selecting one of the plurality of the first sub-request transaction bid and one of the plurality of the second sub-request transaction bid.

14. The computer usable program product of claim 8, wherein the transaction request can be shared by a third party device to another computer network environment via a shared URL, and further comprising:
program instructions to generate transaction credit for the third party device, responsive to a transaction bid submitted through the shared URL being selected by the first computer device.

15. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to store a transaction request generated from a first computer device in a first transaction database;
program instructions to provide the transaction request to a plurality of subscriber computer devices, the subscriber computer devices subscribed to the first transaction database and at least one keyword associated with the transaction request;
program instructions to receive a plurality of transaction bids from at least one of the subscriber computer devices;
program instructions to provide the transaction bids to the first computer device; and
program instructions to establish a network session between the first computer device and a selected subscriber computer device associated with at least one of the selected transaction bids, responsive to the first computer device selecting at least one of the transaction bids.

16. The computer system of claim 15, further comprising:
program instructions to detect that a transaction as specified by the transaction request and the at least one of the selected transaction bids is complete; and
program instructions to terminate the established network session.

17. The computer system of claim 15, wherein the first computer device and the selected subscriber computer device establishes a text chat session after the network session is established and while the network session is active.

18. The computer system of claim 15, wherein the first computer device and the selected subscriber computer device establishes a video streaming session after the network session is established and while the network session is active.

19. The computer system of claim 18, further comprising:
program instructions to determine whether mobile devices corresponding to both of the first computer device and the selected subscriber computer device are active and linked to the established network session; and
program instructions to cause cameras of the mobile devices to become activated for predetermined time as previously specified by the established network session, wherein the cameras of the mobile devices are deactivated once the predetermined time period expires.

20. The computer system of claim 15, further comprising:
program instructions to detect that the transaction request includes a first sub-request and a second sub-request;
program instructions to receive a plurality of first sub-request transaction bids from a first sub-group of the subscriber computer devices and a plurality of second sub-request transaction bids from a second sub-group of the subscriber computer devices; and
program instructions to establish the network session among the first computer device and the subscriber computer devices corresponding to the selected first sub-request transaction bid and the selected second sub-request transaction bid, in response to the first computer device selecting one of the plurality of the first sub-request transaction bid and one of the plurality of the second sub-request transaction bid.
